(19) United States
(12) Patent Application Publication
(10) Pub. No.: US 2006/0186225 A1
(43) Pub. Date: Aug. 24, 2006

(54) Air guide systems and methods for restorative drying

(76) Inventors: Brett Bartholmey, Bellingham, WA (US); William Bruders, Burlington, WA (US)

Correspondence Address: SCHACHT LAW OFFICE, INC., SUITE 202, 2801 MERIDIAN STREET, BELLINGHAM, WA, 98225-2412, US

(21) Appl. No.: 11/358,336

(22) Filed: Feb. 21, 2006

Related U.S. Application Data
(60) Provisional application No. 60/655,946, filed on Feb. 23, 2005.

(51) Int. Cl. B05B 1/14

(52) U.S. Cl. 239/499; 239/519; 239/548; 15/405

(57) ABSTRACT

A system for guiding air to at least one desired location on at least one target surface. The system comprises an air mover and an air guide member. The air mover defines an outlet through which air is displaced. The air guide member defines at least one air chamber. The air guide member is arranged adjacent to the outlet such that at least a first portion of the air displaced by the air mover enters the at least one air chamber to inflate the air guide member. The air mover and air guide member are arranged such that the inflated air guide member guides a second portion of the air towards the at least one desired location.

### RELATED APPLICATIONS

The present invention claims priority of U.S. Provisional Patent Application Ser. No. 60/655,946, filed Feb. 23, 2005. The contents of all related applications listed above are incorporated herein by reference.

### TECHNICAL FIELD

The present invention relates to restorative drying systems and methods and, more particularly, to systems and methods for guiding moving air along a surface to be dried.

### BACKGROUND OF THE INVENTION

In many situations, buildings and fixtures within buildings can become wet. For example, natural floods, sprinkler systems, leaks in plumbing systems, cleaning processes, and the like can all result in water or other fluids soaking into building components such as walls, floors, and ceilings and/or building fixtures such as carpets and cabinets. If not removed, moisture can damage the affected components and/or fixtures.

Typically, it is difficult or impossible to remove a building component to facilitate drying thereof. Accordingly, a variety of restorative drying systems and methods have been developed to remove moisture from buildings and building fixtures in place. A common practice is to arrange an air mover to create air movement along a target surface of the affected building component or fixture. The relatively dry air moving along the relatively moist target surface accelerates drying of the affected component or fixture.

Commercial air movers used for restorative drying are of two basic types: axial and radial. Axial air movers displace air in a column that is substantially parallel to a blade axis. Radial air movers displace air in a sheet that is substantially tangential to a blade axis. In either case, the column or sheet of air is directed towards the target surface such that the air facilitates drying of the affected building component or fixture.

Generally speaking, the use of one or more air movers, possibly in combination with a dehumidifier, substantially decreases the amount of time required to reduce the moisture content of an affected building component or fixture to an acceptable level. However, the need exists for improved restorative drying systems and methods that optimize the operation of existing restorative drying equipment.

### SUMMARY OF THE INVENTION

The present invention may be embodied as a system or method for guiding air to at least one desired location on at least one target surface. The system comprises an air mover and an air guide member. The air mover defines an outlet through which air is displaced. The air guide member defines at least one air chamber. The air guide member is arranged adjacent to the outlet such that at least a first portion of the air displaced by the air mover enters the at least one air chamber to inflate the air guide member. The air mover and air guide member are arranged such that the inflated air guide member guides a second portion of the air towards the at least one desired location.

### BRIEF DESCRIPTION OF THE DRAWINGS

FIG. 1 is a perspective view of a first embodiment of a restorative drying system of the present invention;

FIG. 2 is an end section view illustrating a relationship between the air guide of the restorative drying system of FIG. 1 and a floor structure being dried;

FIG. 3 is a side elevation partial cutaway view depicting the restorative drying system of FIG. 1;

FIGS. 4 and 5 are top and bottom plan view of an air guide used by the restorative drying system of FIG. 1;

FIG. 6 is a perspective view showing one use of the restorative drying system of FIG. 1;

FIG. 7 is a side elevation view showing another example use of the restorative drying system of FIG. 1;

FIG. 8 is an end section view illustrating another example use of the restorative drying system of FIG. 1;

FIG. 9 is also an end section view showing the restorative drying system of FIG. 1 used with a weight to position the air guide;

FIGS. 10 and 11 are end section views showing several different configurations of an air guide relative to an air mover when using the restorative drying system of FIG. 1;

FIG. 12 illustrates an example where two of the restorative drying systems of FIG. 1 are used to create a vertical column of air;

FIG. 13 is a top plan view illustrating the use of two of the restorative drying systems of FIG. 1;

FIG. 14 is a top plan view showing the use of the restorative drying system of FIG. 1 to accommodate an inside corner of a wall;

FIG. 15 is a top plan view illustrating a second example of the restorative drying system of the present invention;

FIG. 16 is a top plan view illustrating a third example of the restorative drying system of present invention;

FIG. 17 is a bottom plan view of the example air guide of the restorative drying system depicted in FIG. 16;

FIG. 18 is a partial, section, side elevation view of the restorative drying system of FIG. 1;

FIG. 19 is an end section view depicting a relationship of an air mover nozzle and attachment portion of the air guide of the restorative drying system of FIG. 16;

FIG. 20 is an end section view illustrating a relationship between the air guide and a floor structure being dried;

FIG. 21 is a side elevation view depicting an example use of the air guide depicted in FIG. 1;

FIG. 22 is a top plan view of yet another embodiment of a restorative drying system of the present invention;

FIG. 23 is a top plan view of still another air guide system of the present invention;

FIG. 24 depicts an example axial air mover system that may be used in a restorative drying system of the present invention;

FIG. 25 is a top plan view depicting yet another example of a restorative drying system of the present invention incorporating an axial air mover as shown in FIG. 24;

FIG. 26 is a side elevation view of another example of a restorative drying system of the present invention;

FIG. 27 is a front elevation, section view illustrating the connecting portion of the air guide of the restorative drying system of FIG. 26;

FIG. 28 is a bottom plan view of air guide of yet another exemplary restorative drying system of the present invention;

FIG. 29 is a section view of another exemplary restorative drying system of the present invention; and

FIG. 30 is a section view taken along lines 30-30 and FIG. 29;

FIG. 31 is a top plan view of yet another exemplary restorative drying system of the present invention;

FIG. 32 is a side elevation view of the restorative drying system depicted in FIG. 31;

FIG. 33 is a bottom plan view of the restorative drying system depicted in FIG. 31;

FIG. 34 is a side elevation, partial cutaway view of the restorative drying system depicted in FIG. 31;

FIG. 35 is a section view taken along lines 35-35 in FIG. 31;

FIG. 36 is a section view taken along lines 36-36 in FIG. 31;

FIG. 37 is a top plan view of yet another exemplary restorative drying system of the present invention; and

FIG. 38 is a section view taken along lines 38-38 in FIG. 37.

### DETAILED DESCRIPTION OF THE INVENTION

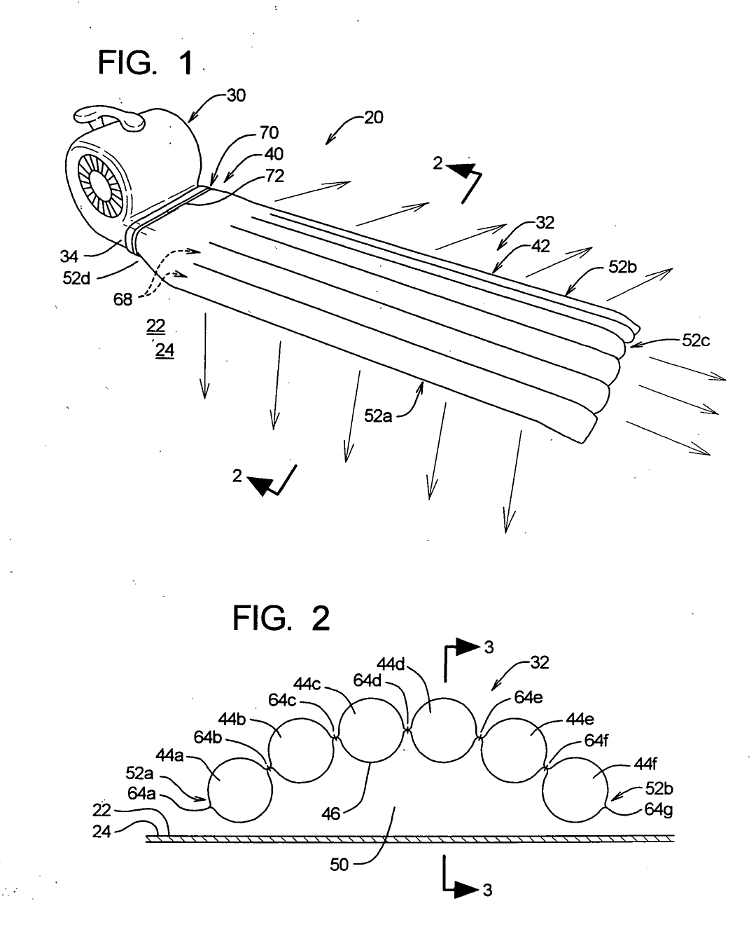

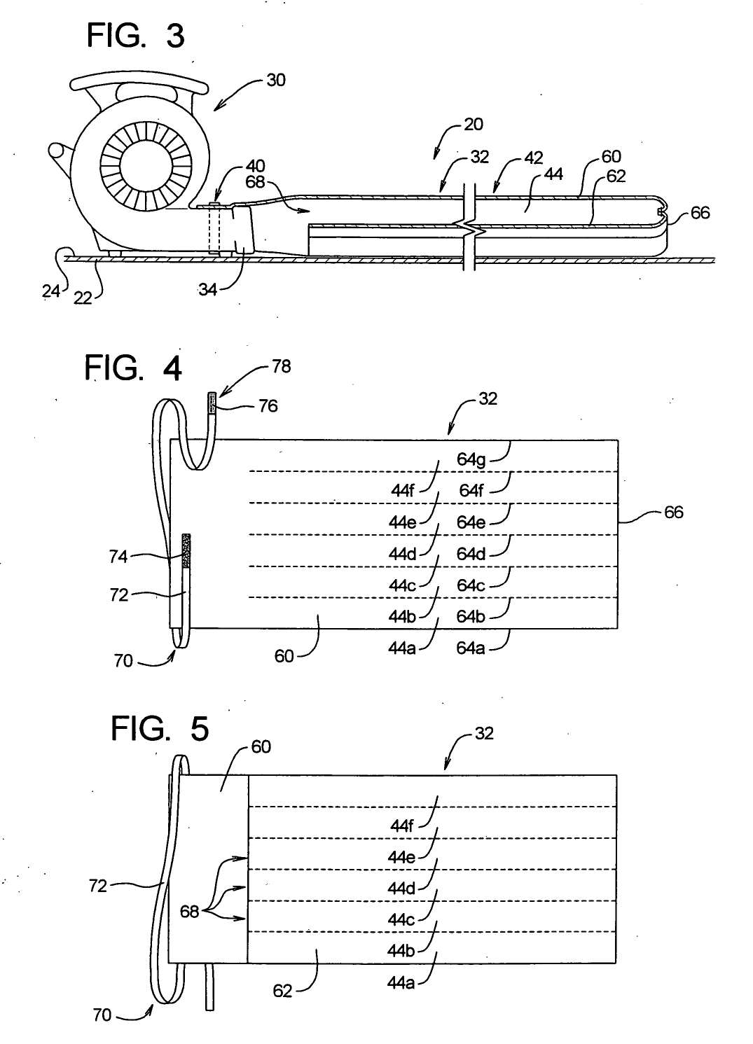

Referring initially to FIGS. 1-14 of the drawing, depicted at 20 therein is a first example of a restorative drying system constructed in accordance with, and embodying, the principles of the present invention. In FIGS. 2 and 3, the restorative drying system 20 is depicted in a configuration appropriate for removing moisture from a floor structure 22 defining a target surface 24.

The example restorative drying system 20 comprises an air mover 30 and an air guide 32. The example air mover 30 is or may be a conventional radial air mover of the type commonly used in the restorative drying industry. The example air guide 32 is secured to the air mover 30 to guide air exiting through a nozzle or outlet 34 of the air mover 30 along the target surface 24 of the floor structure 22. The air guide 32 helps maintain air displaced by the air mover 30 closely adjacent to the target surface 24.

Without the air guide 32, a substantial portion of the relatively dry air displaced by the air mover 30 flows along a path that diverges from the plane formed by the target surface 24. The air that diverges from the target surface 24 contributes little if any to the removal of moisture from the floor structure 22. By maintaining the air displaced from the air mover 30 relatively close to the target surface 24 over a larger surface area, the air guide 32 increases the efficiency with which moisture is removed from the floor structure 22.

A primary feature of the air guide 32 is thus to decrease the amount of time air mover 30 must be operated to reduce the moisture content of the floor structure 22 to an acceptable level. The air guide 32 also functions to muffle the sound created by the air mover 30.

The example air guide 32 depicted in FIGS. 1-14 is formed of a flexible material configured to define an attachment portion 40 and a guide portion 42. The attachment portion 40 is adapted to be connected to the air mover 30. The guide portion 42 defines at least one air chamber 44 that is arranged relative to the nozzle 34 of the air mover 30 such that a portion of the air exiting the nozzle 34 enters and inflates the at least one air chamber 44. The example air guide 32 comprises six air chambers 44a-f, but more or fewer air chambers 44 may be used.

When the at least one air chamber 44 inflates, the air guide 32 defines a guide surface 46 that is arranged to face the target surface 24. In addition, when the attachment portion 40 is secured to the air mover 30, a substantial portion of the air exiting the nozzle 34 flows between the target surface 24 and the guide surface 46. The air flowing between the target surface 24 and the guide surface 46 causes the guide portion 42 of the air guide 32 to float a short distance above the target surface 24 as perhaps best shown in FIG. 2.

The guide surface 46 and the target surface 24 thus define a guide space 50 along which the air flowing out of the nozzle 34 passes. The guide space 50 is not sealed. Air may and does easily flow out of the guide space 50 along first and second side edges 52a and 52b and a distal end edge 52c thereof. A proximal end edge 52d of the guide space 50 is below the nozzle 34 of the air mover 30. Air exiting the nozzle 34 of the air mover 30 travels away from the distal end edge 52d. Accordingly, while this distal end edge 52d is also not sealed, in general significantly less air flows out of the guide space 50 through this distal end edge 52d than along the other three edges 52a, 52b, and 52c.

As shown in FIG. 3, the air guide 32 comprises an upper panel 60 and a lower panel 62 defining the guide surface 46. In the example air guide 32, the six air chambers 44a-f are formed by seven longitudinal seams 64a-g and one end seam 66 connecting the panels 60 and 62, but the air chambers 44 may be formed by other structures.

Each air chamber 44 defines an inlet 68 that allows air to enter the chamber 44. The example inlets 68 are formed by locations where the panels 60 and 62 are not attached. While not sealed, the chambers 44 are sufficiently air tight to inflate and stay inflated as long as the air mover 30 is operating. Once the chambers 44 are inflated, very little of the air that exits the nozzle 34 of the air mover 30 actually enters the chambers 44; the back pressure created by air already within the chambers 44 causes almost all of the air exiting the nozzle 34 to pass into the guide space 50.

When the air mover 30 is turned off, the air within the chambers 44 escapes through the inlets 68 and/or along the seams 64, 66 to allow the air guide 32 to deflate. Once deflated, the air guide 32 may be detached from the air mover 30 and folded for storage.

The example attachment portion 40 will now be described in further detail with reference to FIGS. 4 and 5. The attachment portion 40 is formed by a portion of the upper panel 60 that extends beyond the lower panel 62 as shown in FIG. 5. When secured to the nozzle 34, the attachment portion 40 spaces the inlets 68 a short distance downstream of the nozzle 34.

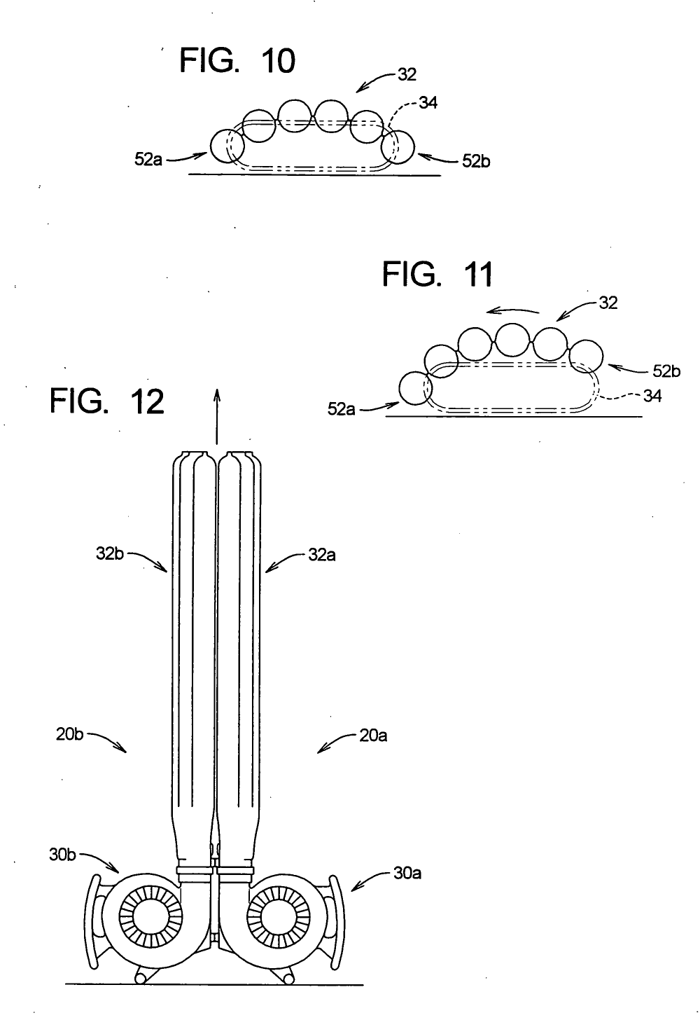

The example air guide 32 further comprises an attachment system 70 formed by a strap member 72 defining first and second ends 74 and 76. The strap member 72 is sewn or glued to or inserted through openings in the attachment portion 40. The ends 74 and 76 of the strap member 72 are then arranged around the nozzle 34 and connected together using a fastening system 78 formed by buckles, hook and loop fasteners, or the like. As shown in FIGS. 10 and 11, the attachment system 70 allows the orientation of the air guide 32 relative to the nozzle 34 to be changed. The user may thus configure the air guide 32 such that more air exits the guide space 50 through one or the other of the side edges 52a and 52b.

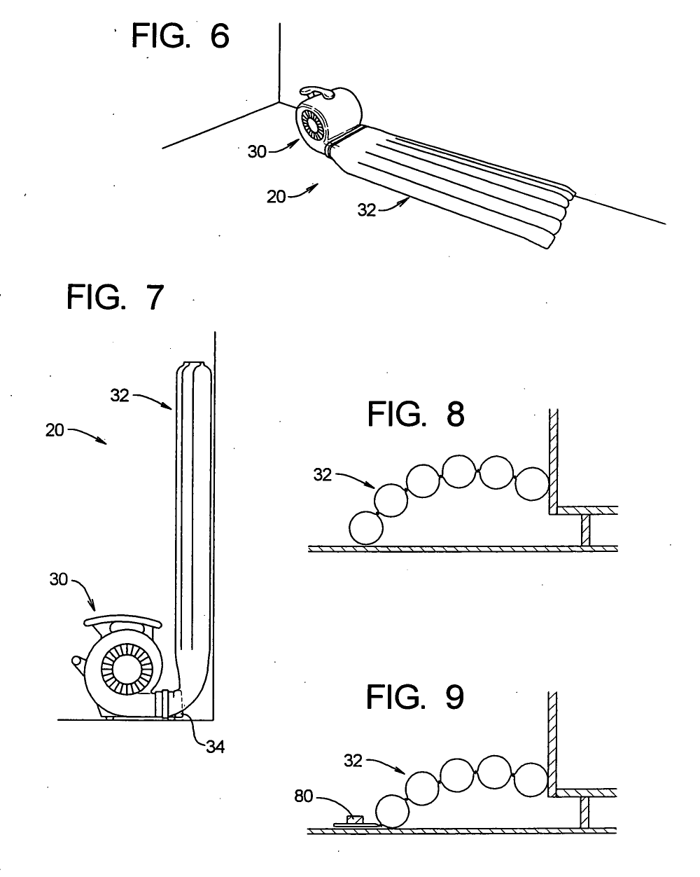

The air guide 32 may be used in a number of different configurations, alone or in combination with other air guides of similar construction. The air guide 32 may also be used at a baseboard location of a wall adjacent to a floor (FIG. 6) or at the juncture of a floor and a cabinet (FIGS. 8 and 9). FIG. 9 shows a weight 80 arranged to hold down one side edge of the air guide 32. In these situations, the user may want to adjust the location of the air guide 32 relative to the nozzle 34 as shown in FIG. 11 such that more air flows towards the wall or cabinet.

The air guide 32 may also be arranged along a vertical corner between two adjacent walls as shown in FIG. 7, in which case the user may adjust the location of the air guide 32 relative to the nozzle 34 as shown in FIG. 11. Similarly, two air guides 32a and 32b with associated blowers 30a and 30b may be arranged to form a vertical column of air as shown in FIG. 12, in which case the air guides 32a and 32b may be arranged relative to the nozzle 34 as shown in FIG. 10.

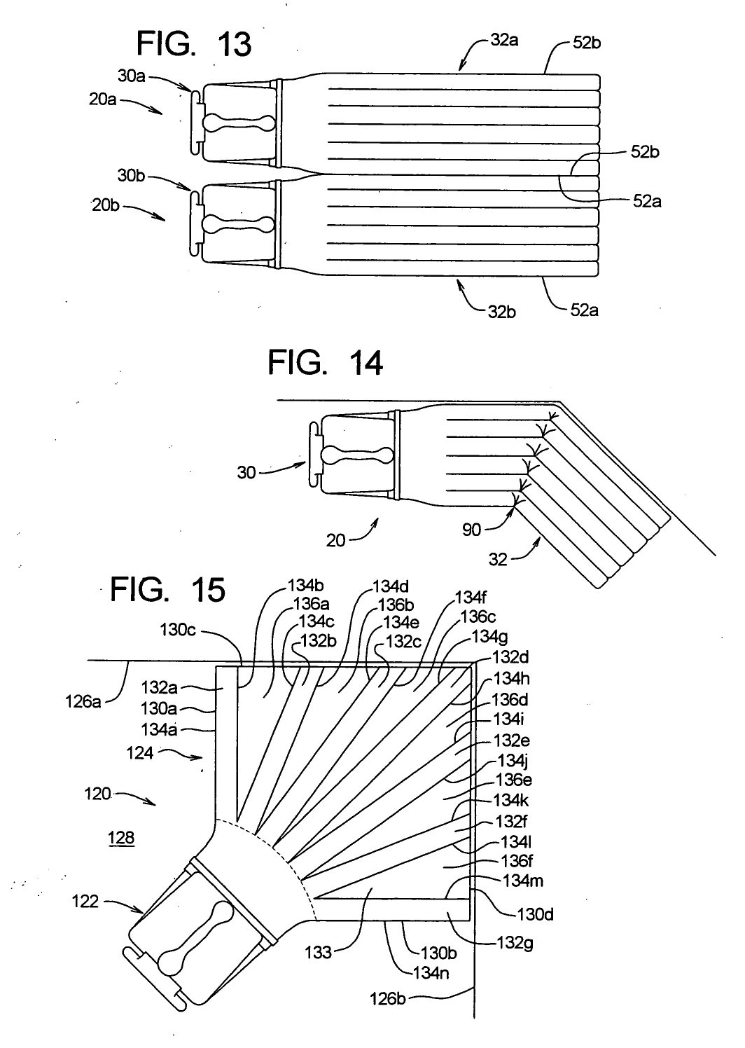

FIG. 13 shows two of the air guides 32a and 32b being used at the same time, with the side edge 52a of the air guide 32a being adjacent to the side edge 52b of the air guide 32b. Fasteners such as snap fasteners, hook and loop fasteners, or the like may be used to connect the adjacent edges together.

FIG. 14 shows the air guide 32 being used to direct air along a baseboard portion of an inside corner of a wall. In this case, a crease 90 is formed in the air guide 32 to allow the air guide to follow the inside corner. Again, a fastener may optionally be used to fix the air guide 32 in a configuration that matches the angle formed by the inside corner of the wall.

Referring now to FIG. 15, depicted at 120 therein is a second example of a restorative drying system comprising an air mover 122 and an air guide 124. The restorative drying system 120 may be used and operated in a manner that is generally similar to that of the system 20 described above. In particular, the example air mover 122 is or may be, like the air mover 30 above, a conventional radial air mover. The air guide 124 is adapted to direct air into a corner region defined by the intersection of two walls 126a and 126b and a floor 128.

The example air guide 124 defines first and second side edges 130a and 130b a first and second distal edges 130c and 130d. The side edges extend from the air mover 122 at substantially a right angle to each other. The distal edges 130c and 130d also extend at substantially a right angle to each other. The first distal edge 130c extends at substantially a right angle to the first side edge 130a, while the second distal edge 130d extends at substantially a right angle to the second side edge 130b. The overall shape of the air guide 124 is thus rectangular or square.

The example air guide 124 is formed by a plurality of chambers 132a-g extending from the air mover 122 to the distal edges 130c and 130d. In the example air guide 124, the example chambers 132 are formed by an upper panel 133 and lower panel (not shown in FIG. 15) joined at seams 134a-n. The example chambers 132 are thus separated by voids 136a-f. The air guide 124 is connected to the air mover 122 such that at least a portion of the air exiting the air mover 122 enters the chambers 132. The chambers 132 inflate and carry the voids 136 above the floor 128 such that the bottom surface (not shown) of the air guide 124 guides air from the air mover 122 along the floor 128 towards the distal edges 130c and 130d.

In use, the air mover 122 is directed towards the vertical corner formed by the two intersecting walls 126a and 126b, with the two distal edges 130c and 130d adjacent to the two intersecting walls 126a and 126b as shown in FIG. 15. The air mover 122 is then operated to cause air to flow under the air guide 124 towards the walls 126a and 126b. Air flowing under the air guide 124 will flow out along the side and distal edges 130.

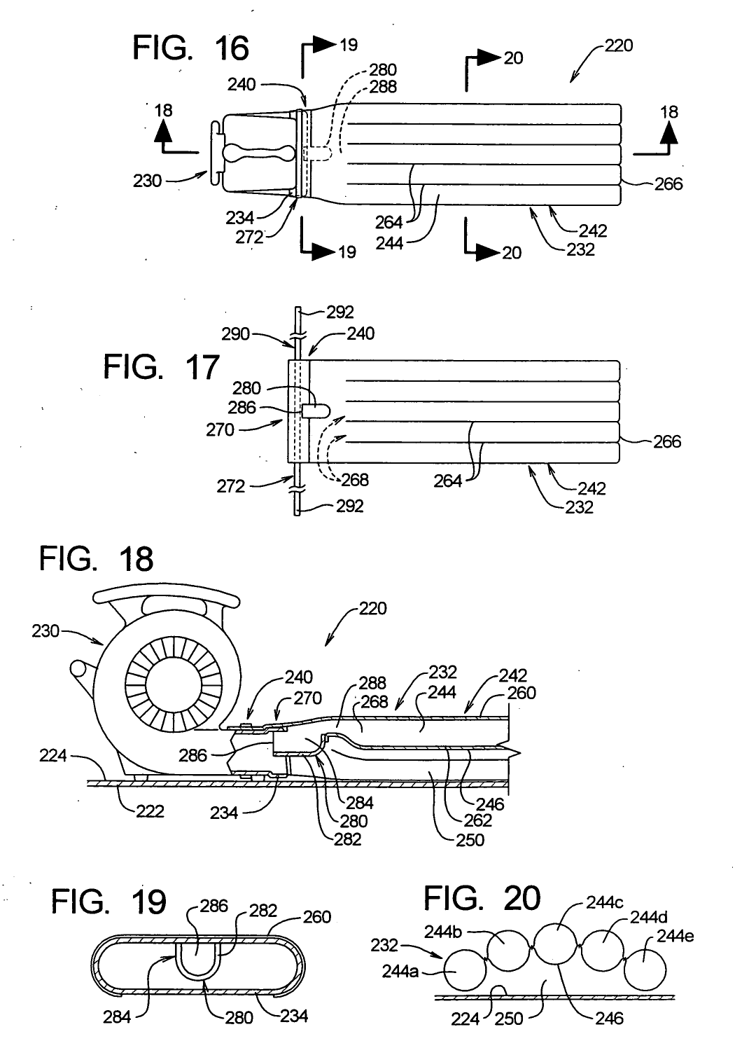

Turning now to FIGS. 16-20, depicted therein at 220 is a third example restorative drying system of the present invention. In FIGS. 18 and 20, the restorative drying system 20 is depicted in a configuration appropriate for removing moisture from a floor structure 222 defining a target surface 224. The restorative drying system 220 may be used and operated in a manner that is generally similar to that of the systems 20 and 120 described above.

The example restorative drying system 220 comprises an air mover 230 and an air guide 232. Like the air movers 30 and 122 described above, the example air mover 230 is or may be a conventional radial air mover of the type commonly used in the restorative drying industry.

The example air guide 232 is secured to the air mover 230 to guide air exiting through a nozzle 234 of the air mover 230 along the target surface 224 of the floor structure 222. The air guide 232 helps maintain air displaced by the air mover 230 closely adjacent to the target surface 224.

The example air guide 232 depicted in FIGS. 16-20 is formed of a flexible material configured to define an attachment portion 240 and a guide portion 242. The attachment portion 240 is adapted to be connected to the air mover 230. The guide portion 242 defines at least one air chamber 244 that is arranged relative to the nozzle 234 of the air mover 230 such that a portion of the air exiting the nozzle 234 enters and inflates the at least one air chamber 244. The example air guide 232 comprises five air chambers 244a-e, but more or fewer air chambers 244 may be used.

When the at least one air chamber 244 inflates, the air guide 232 defines a guide surface 246 that is arranged adjacent to the target surface 224. In addition, when the attachment portion 240 is secured to the air mover 230, a substantial portion of the air exiting the nozzle 234 flows between the target surface 224 and the guide surface 246. The air flowing between the target surface 224 and the guide surface 246 causes the guide portion 242 of the air guide 232 to float a short distance above the target surface 224. The guide surface 246 and the target surface 224 thus define a guide space 250 along which the air flowing out of the nozzle 234 passes. The guide space 250 is not sealed.

As shown in FIG. 18, the air guide 232 comprises an upper panel 260 and a lower panel 262 defining the guide surface 246. In the example air guide 232, the five air chambers 244 are formed by six longitudinal seams 264 and a distal end seam 266 connecting the panels 260 and 262, but the air chambers 244 may be formed by other structures.

Each air chamber 244 defines an inlet 268 that allows air to enter the chamber 244. The example inlets 268 are formed by locations where the panels 260 and 262 are not attached. While not sealed, the chambers 244 are sufficiently air tight to inflate and stay inflated as long as the air mover 230 is operating. When the air mover 230 is turned off, the air within the chambers 244 escapes through the inlets 268 and/or along the seams 264, 266 to allow the air guide 232 to deflate. Once deflated, the air guide 232 may be detached from the air mover 230 and folded for storage.

The example attachment portion 240 will now be described in further detail with reference to FIGS. 16-19. The attachment portion 240 is formed by a portion of the upper panel 260 that extends beyond the lower panel 262 as shown in FIG. 17. When secured to the nozzle 234, the attachment portion 240 spaces the inlets 268 a short distance downstream of the nozzle 234.

The example air guide 232 further comprises a scoop system 270 and an attachment system 272. The scoop system 270 comprises a relatively rigid scoop member 280 configured to define a scoop portion 282. The scoop portion 282 defines a scoop chamber 284 and a scoop opening 286. The scoop member 280 is sewn to the upper and lower panels 260 and 262 to form a manifold chamber 288 downstream of the scoop portion 282.

The scoop chamber 284 is in fluid communication with the manifold chamber 288, and the manifold chamber 288 is in turn in fluid communication with the inlets 268 of the chambers 244. Substantially all of the air entering the chambers 244 through the inlets 268 thus must pass first through the scoop chamber 284 and then through the manifold chamber 288.

The shape and dimensions of the scoop member 280 thus generally determine the amount of air that enters and inflates the chambers 244. The designer of the system 220 may thus control, within general parameters, the amount of the air pressure within the chambers 244. By controlling the amount of air pressure within the chambers 244, the designer can ensure that the air guide 232 is sufficiently inflated to perform the function of guiding the air within the guide space 250 but is not over-inflated such that the air guide 232 exhibits potentially undesirable behavior such as flapping or the like.

The example air guide member 232 is formed by material that is sufficiently rigid to hold the shape of the scoop portion 282. Although the air guide member 232 may be rigid, the example air guide member 232 is made of semi-rigid foam material.

The attachment system 272 comprises a strap member 290 that is sewn or glued to or inserted through openings in the attachment portion 240. The ends 292 of the strap member are then arranged around the nozzle 234 and connected together using a fastening system formed by buckles, hook and loop fasteners, or the like.

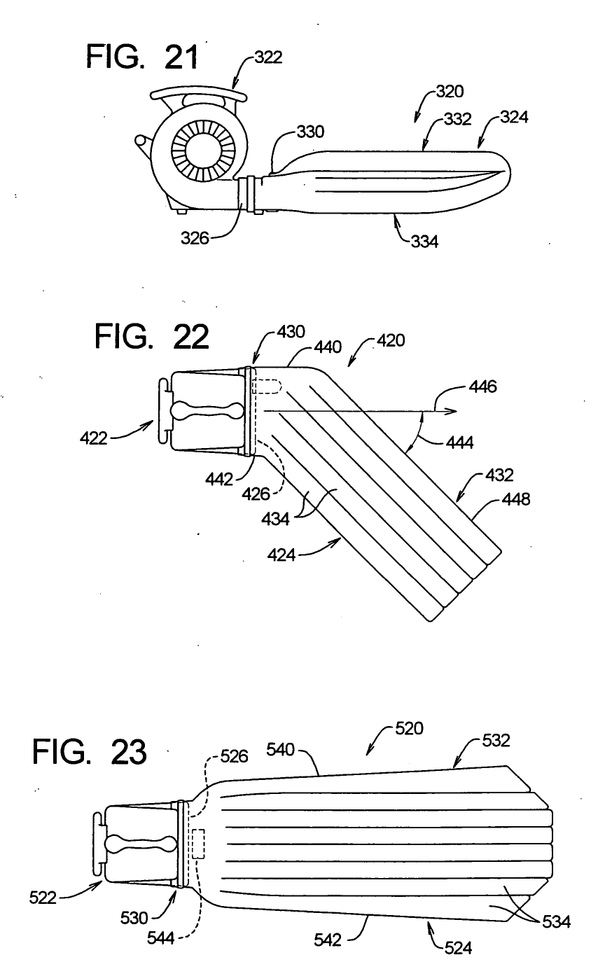

Turning now to FIG. 21, depicted at 320 therein is a fourth example restorative drying system of the present invention. The restorative drying system 320 may be constructed, used, and operated in a manner that is generally similar to that of the systems 20, 120, and 220 described above. In particular, the restorative drying system 320 comprises an air mover 322 and an air guide 324. The air guide 324 is connected to the air mover 322 to guide air exiting a nozzle 326 of the air mover 322 to a desired location.

The example air guide 324 is provided with a fastening means 330 that allows a distal portion 332 thereof to be doubled back on a proximal portion 334. Accordingly, in some situations, such as when the system 320 is to be used in a relatively confined space, the effective length of the air guide 324 can be shortened using fastening means 330.

FIG. 22 depicts a fifth example restorative drying system 420 of the present invention. The restorative drying system 420 may be constructed, used, and operated in a manner that is generally similar to that of the systems 20, 120, 220, and 320 described above. In particular, the restorative drying system 420 comprises an air mover 422 and an air guide 424. The air guide 424 is connected to the air mover 422 to guide air exiting a nozzle 426 of the air mover 422 to a desired location.

The example air guide 424 is formed of a flexible material configured to define an attachment portion 430 and a guide portion 432. Like the attachment portion 40 described above, the attachment portion 430 is adapted to be connected to the air mover 422. The guide portion 432 is similar to the guide portion 42 in that it defines at least one air chamber 434 that is arranged relative to the nozzle 426 such that a portion of the air exiting the nozzle 426 enters and inflates the at least one air chamber 434.

However, the attachment portion 430 is longer along a first edge 440 than along a second edge 442. The relative lengths of the edges 440 and 442 of the attachment portion 430 cause the air guide 424 to extend at an angle 444 relative to a flow direction 446 at which air exits the air mover nozzle 426. The angle 444 at which air guide 424 extends relative to the flow direction 446 allows an engaging edge 448 of the guide portion 432 that intersects the first edge 440 of the attachment portion 430 to placed directly against a wall, cabinetry, or other structure to be dried. The air mover 422 is thus spaced from the structure being dried when system 420 is under normal use. The restorative drying system 420 is less likely to result in damage to the structure being dried because only the soft air guide 424, and not the rigid air mover 422, is likely to come into contact with the structure being dried.

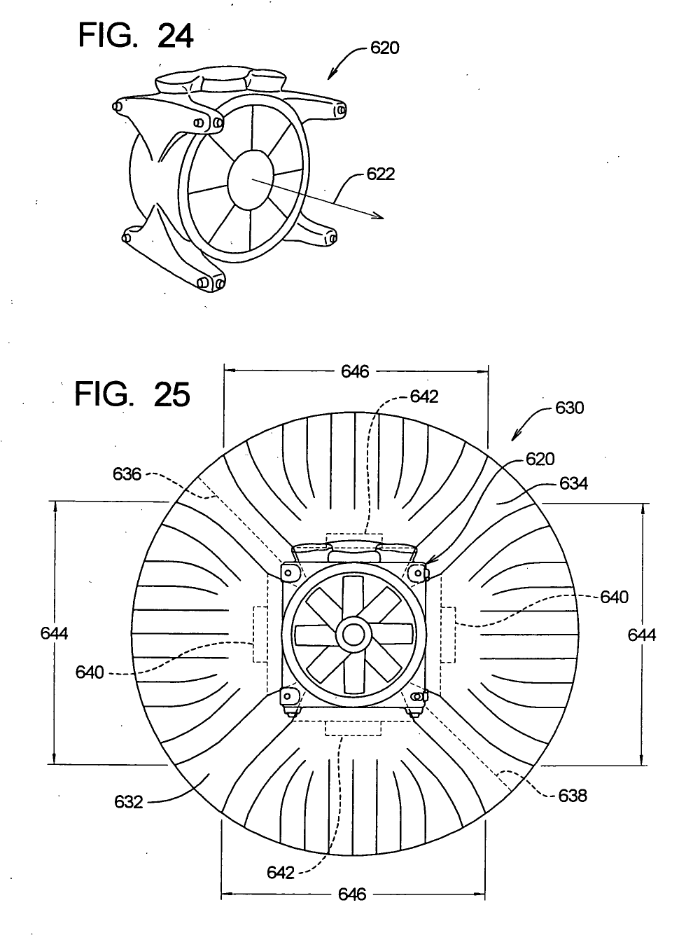

FIG. 23 depicts a sixth example restorative drying system 520 of the present invention. The restorative drying system 520 may be constructed, used, and operated in a manner that is generally similar to that of the systems 20, 120, 220, 320, and 420 described above. In particular, the restorative drying system 520 comprises an air mover 522 and an air guide 524. The air guide 524 is connected to the air mover 522 to guide air exiting a nozzle 526 of the air mover 522 to a desired location.

The example air guide 524 is formed of a flexible material configured to define an attachment portion 530 and a guide portion 532. Like the attachment portions 40 and 430 described above, the attachment portion 530 is adapted to be connected to the air mover 522. The guide portion 532 is similar to the guide portion 42 in that it defines at least one air chamber 534 that is arranged relative to the nozzle 526 such that a portion of the air exiting the nozzle 526 enters and inflates the at least one air chamber 534. The air guide 524 further defines side edges 544 and 542 that are slightly flared to increase a surface area or footprint of the guide portion 532. The air guide 524 includes a scoop member 540 for directing air exiting the nozzle 526 into the at least one air chamber4 534.

The restorative drying system 520 is optimized for removing moisture from a floor structure in a relatively open area. Again, the restorative drying system may be used alone or with other restorative drying systems as described herein.

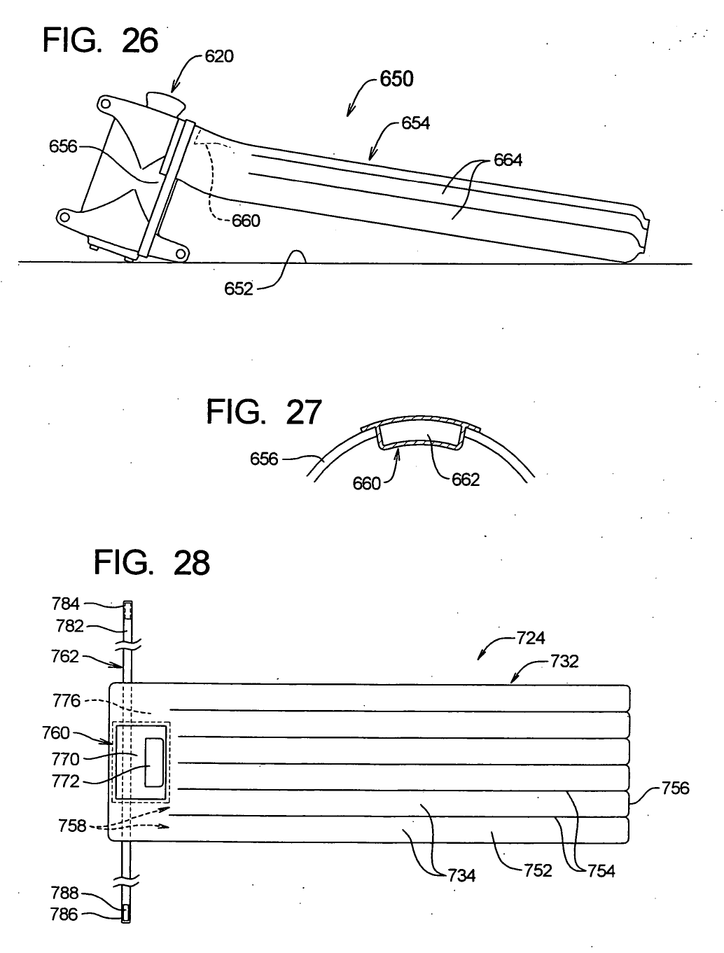

Referring now to FIG. 24 of the drawing, depicted at 620 therein is an axial type air mover as is conventionally used in the restorative drying industry. The example air mover 620 moves air along an axis 622 defined by the air mover 620. The axial air mover 620 may be arranged in a side configuration, with the axis 622 thereof substantially horizontal (FIGS. 24 and 26), or in an end configuration, with the axis 622 is substantially vertical (FIG. 25). The axial air mover 620 may be used as part of a restorative drying system of the present invention in either the side configuration or in the end configuration.

Referring now to FIG. 25, depicted at 630 therein is first example restorative drying system using the axial air mover 620 described above. In the system 630, the air mover 620 is arranged in its end configuration, with the air moved thereby being displaced towards a floor structure.

The example system 630 further comprises first and second separate air guides 632 and 634. The example air guides 632 and 634 are identical and each extends through an angle of approximately 180° around a circle centered at the system axis 622. Radial edges of the example air guides 632 and 634 are joined at edge locations 636 and 638 such that the air guides 632 and 634 overlap at the edge locations 636 and 638 and thus extend around the entire circle centered at the system axis 622. Snap fasteners, hook and loop fasteners, or the like may be used to join the radial edges at the edge locations 636 and 638.

The air guides 632 and 634 each comprise a plurality of air scoops depicted at 640 and 642 in FIG. 25. The air scoops 640 and 642 are configured to supply air to first and second sets of 644 and 646 of chambers defined by the air guides 632 and 634.

The example drying system 630 is optimized for removing moisture from a floor structure in a relatively open area. Again, the restorative drying system may be used alone or with other restorative drying systems as described herein.

FIGS. 26 and 27 illustrate a second example restorative drying system 650 using the axial air mover 620 described above. In the system 650, the air mover 620 is arranged in its side configuration, with the air moved thereby being displaced along a floor structure 652.

The example system 650 further comprises an air guide 654. The example air guide 654 is in the same basic shape as the air guide 32 described above. However, as shown in FIG. 27, the air guide 654 comprises a scoop member 660 adapted to fit the shape of a housing 656 of the axial air mover 620. In particular, the scoop member 660 is slightly curved to follow the curve of a housing 656 of the air mover 620. In addition, the scoop member 660 defines a relatively wide, flat scoop portion 662 that is sized and dimensioned to allow a proper amount of air into chambers 664 defined by the air guide 654.

The example drying system 650 may be used in the same general manner as the drying system 20 described above. Again, the restorative drying system 650 may be used alone or with other restorative drying systems as described herein.

Referring now to FIGS. 28-30, depicted at 720 therein is yet another example restorative drying system constructed in accordance with, and embodying, the principles of the present invention. The restorative drying system 720 comprises a radial air mover 722 and an air guide 724. The air drying system 720 is assembled and operated in a similar manner to the air drying system 20 described above to remove air from a floor structure 726 defining a target surface 728.

In particular, the air guide 724 is formed of a flexible material configured to define an attachment portion 730 and a guide portion 732. The attachment portion 730 is adapted to be connected to the air mover 722. The guide portion 732 defines at least one air chamber 734 that is arranged relative to the nozzle 735 of the air mover 722 such that a portion of the air exiting the nozzle 735 enters and inflates the at least one air chamber 734.

When the at least one air chamber 734 inflates, the air guide 724 defines a guide surface 736 that is arranged to face the target surface 728 and a substantial portion of the air exiting the nozzle 735 flows between the target surface 728 and the guide surface 736. The air flowing between the target surface 728 and the guide surface 736 causes the guide portion 732 of the air guide 724 to float a short distance above the target surface 728. The guide surface 736 and the target surface 728 thus define a guide space 740 along which the air flowing out of the nozzle 735 passes. The guide space 740 is not sealed.

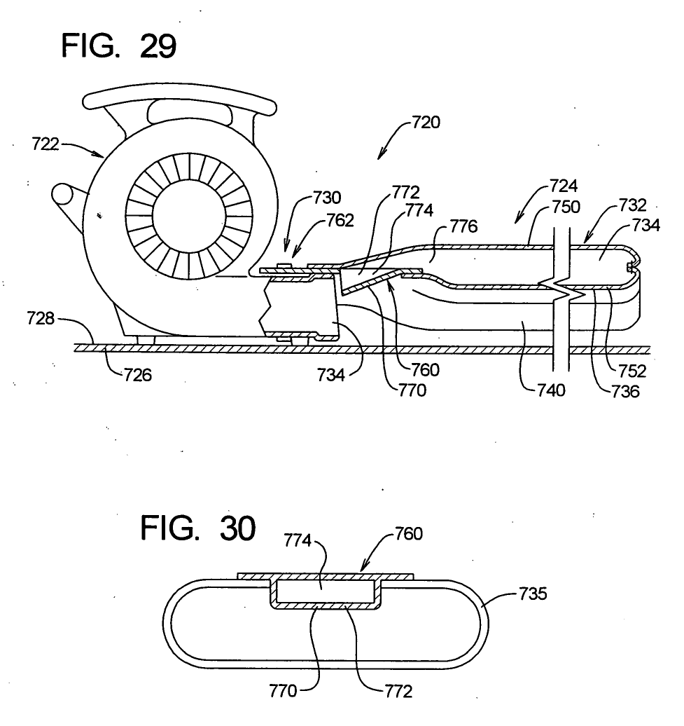

As shown in FIG. 29, the air guide 724 comprises an upper panel 750 and a lower panel 752 defining the guide surface 736. In the example air guide 724, the air chambers 734 are formed by longitudinal seams 754 and one end seam 756 connecting the panels 750 and 752, but the air chambers 734 may be formed by other structures.

Each air chamber 734 defines an inlet 758 that allows air to enter the chamber 734. While not sealed, the chambers 734 are sufficiently air tight to inflate and stay inflated as long as the air mover 722 is operating. The example attachment portion 730 is formed by a portion of the upper panel 750 that extends beyond the lower panel 752 as shown in FIG. 29.

The example air guide 724 further comprises a scoop system 760 and an attachment system 762. The scoop system 760 comprises a relatively rigid scoop member 770 configured to define a scoop portion 772. The scoop portion 772 defines a scoop chamber 774. The scoop member 770 is sewn to the upper and lower panels 750 and 752 to form a manifold chamber 776 downstream of the scoop portion 772. The manifold chamber 776 is defined in part by the outermost side longitudinal seams 754 and in part by proximal end seams 756.

The scoop chamber 774 is in fluid communication with the manifold chamber 776, and the manifold chamber 774 is in turn in fluid communication with the inlets 758 of the chambers 734. Substantially all of the air entering the chambers 734 through the inlets 758 thus must pass first through the scoop chamber 774 and then through the manifold chamber 776. The shape and dimensions of the scoop member 770 thus generally determine the amount of air that enters and inflates the chambers 734. The example scoop member 770 defines a generally flat, shallow scoop chamber 774.

The example scoop member 770 is formed by material that is sufficiently rigid to hold the shape of the scoop portion 772. Although the scoop member 770 may be rigid, the example scoop member 770 is made of semi-rigid foam material.

The attachment system 762 comprises a strap member 782 defining first and second ends 784 and 786. The strap member 782 is sewn or glued to or inserted through openings in the attachment portion 730. The ends 784 and 786 of the strap member 782 are then arranged around the nozzle 735 and connected together using a fastening system 788 formed by buckles, hook and loop fasteners, or the like.

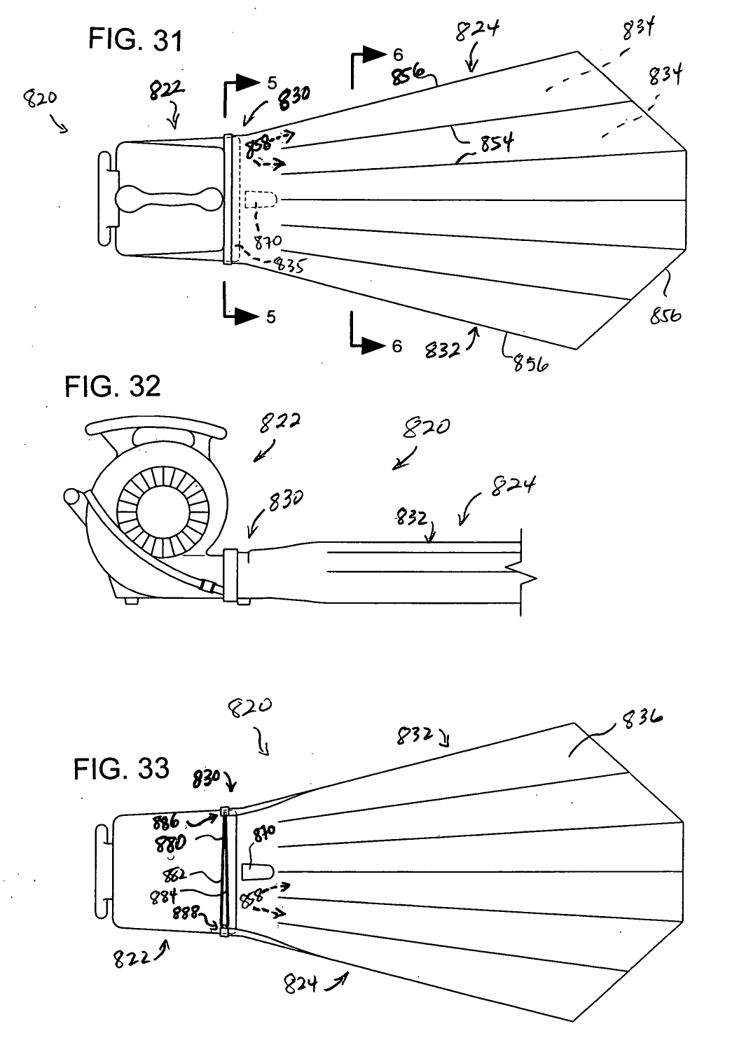

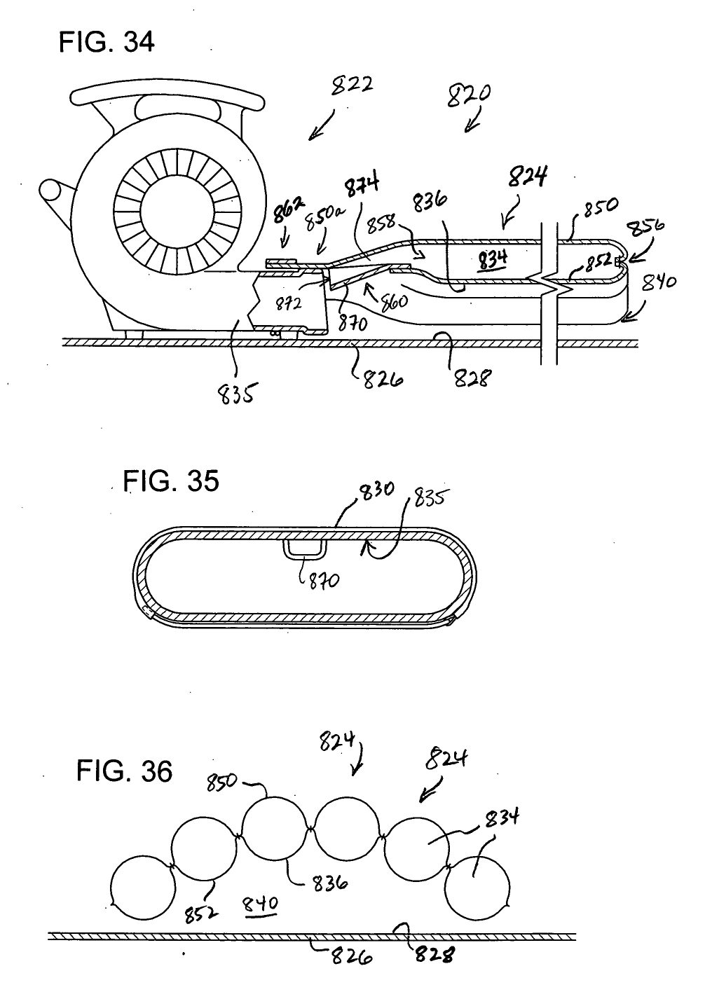

Referring now to FIGS. 31-36, depicted at 820 therein is yet another example restorative drying system constructed in accordance with, and embodying, the principles of the present invention. The restorative drying system 820 comprises an air mover 822 and an air guide 824. As shown in FIGS. 34 and 36, the air drying system 820 is assembled and operated in a similar manner to the air drying system 20 described above to remove air from a floor structure 826 defining a target surface 828.

In particular, the air guide 824 is formed of a flexible material configured to define an attachment portion 830 and a guide portion 832. The attachment portion 830 is adapted to be connected to the air mover 822. The guide portion 832 defines at least one air chamber 834 that is arranged relative to a nozzle 835 of the air mover 822 such that a portion of the air exiting the nozzle 835 enters and inflates the at least one air chamber 834.

When the at least one air chamber 834 inflates, the air guide 824 defines a guide surface 836 that is arranged to face the target surface 828 and a substantial portion of the air exiting the nozzle 835 flows between the target surface 828 and the guide surface 836. The air flowing between the target surface 828 and the guide surface 836 causes the guide portion 832 of the air guide 824 to extend a short distance above the target surface 828. The guide surface 836 and the target surface 828 thus define a guide space 840 along which the air flowing out of the nozzle 835 passes. The guide space 840 is not sealed.

As shown in FIG. 34 and 36, the air guide 824 comprises an upper panel 850 and a lower panel 852 defining the guide surface 836. In the example air guide 824, the air chambers 834 are formed by longitudinal seams 854 (FIGS. 31 and 33) and one edge seam 856 (FIG. 34) connecting the panels 850 and 852, but the air chambers 834 may be formed by other structures. The seams 854 and 856 of the example air guide 824 are slightly angled with respect to each other so that, as shown in FIGS. 31 and 33, an overall shape of the air guide 824 is slightly fan-shaped. The example system 820 may be used in many different configurations but is optimized for use in drying a fairly large floor surface.

Each air chamber 834 defines an inlet 858 that allows air to enter the chamber 834. While not sealed, the chambers 834 are sufficiently air tight to inflate and stay inflated as long as the air mover 822 is operating.

The example attachment portion 830 is formed by a portion 850a of the upper panel 850 that extends beyond the lower panel 852 as shown in FIG. 34.

The example air guide 824 further comprises a scoop system 860 and an attachment system 862. The scoop system 860 comprises a relatively rigid scoop member 870 configured to define a scoop inlet 872. The scoop member 870 is sewn to the upper and lower panels 850 and 852 to form a manifold chamber 874 downstream of the scoop inlet 872. The manifold chamber 874 is defined in part by the outermost side longitudinal seams 854 and in part by the edge seam 856.

The scoop inlet 872 is in fluid communication with the manifold chamber 874, and the manifold chamber 874 is in turn in fluid communication with the inlets 858 of the chambers 834. Substantially all of the air entering the chambers 834 through the inlets 858 thus must pass first through the scoop inlet 872 and then through the manifold chamber 874. The shape and dimensions of the scoop member 870 thus generally determine the amount of air that enters and inflates the chambers 834. The example scoop member 870 defines a generally rectangular scoop inlet 872, but other shapes and dimensions may be used.

The example scoop member 870 is formed by material that is sufficiently rigid to hold the shape of the scoop inlet 872. Although the scoop member 870 may be rigid or flexible, the example scoop member 870 is made of semi-rigid foam material.

The example attachment system 862 comprises a cord member 880 formed in a loop to define first and second portions 882 and 884. The example cord member 880 extends through opening portions 886 and 888 of the attachment portion 830. The example cord member 880 is resilient and arranged to resiliently oppose movement of the opening portions 886 and 888 away from each other when the opening portions are separated by more than a minimum spacing distance. The minimum spacing is predetermined so that, when the attachment portion 830 is around the blower nozzle 835, the cord member 880 is under tension. Further, the minimum spacing is such that the tension applied by the cord member 880 to the opening portions 886 and 884 holds the air guide 824 on the blower nozzle 835.

FIG. 32 further shows that the example attachment system 862 comprises an optional strap assembly 890. The strap assembly 890 extends around the blower 822 to prevent the air guide 824 from blowing away should the air guide 824 not stay on the blower nozzle 835. The strap assembly 890 is preferably extensible to allow the strap assembly to accommodate blowers of different sizes and shapes.

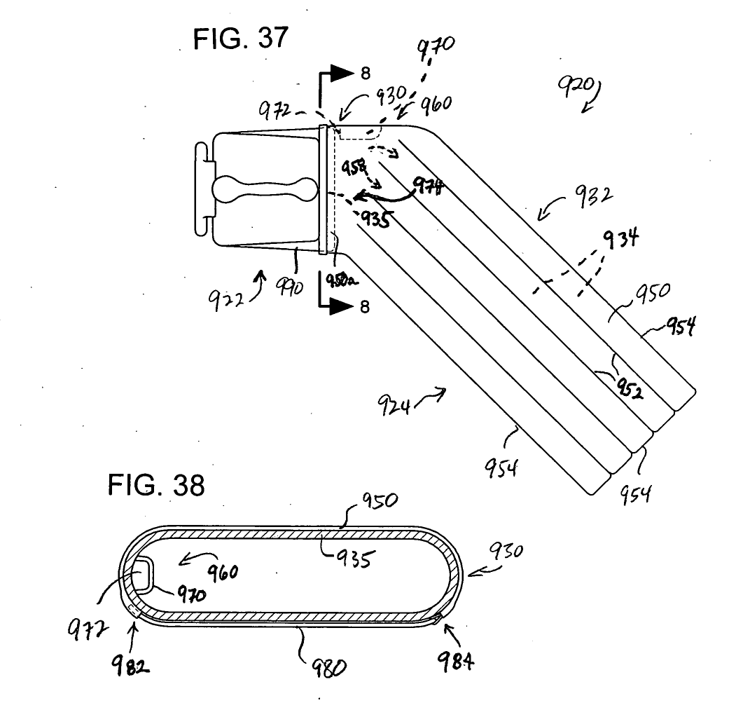

Referring now to FIGS. 37 and 38, depicted at 920 therein is yet another example restorative drying system constructed in accordance with, and embodying, the principles of the present invention. The restorative drying system 920 comprises an air mover 922 and an air guide 924. As shown in FIGS. 34 and 36, the air drying system 920 is assembled and operated in a similar manner to the air drying system 20 described above to remove air from a floor structure defining a target surface.

In particular, the air guide 924 is formed of a flexible material configured to define an attachment portion 930 and a guide portion 932. The attachment portion 930 is adapted to be connected to the air mover 922. In particular, the guide portion 932 defines at least one air chamber 934 that is arranged relative to a nozzle 935 of the air mover 922 such that a portion of the air exiting the nozzle 935 enters and inflates the at least one air chamber 934.

When the at least one air chamber 934 inflates, the air guide 924 defines a guide surface that is arranged to face the target surface, and a substantial portion of the air exiting the nozzle 935 flows between the target surface and the guide surface. The air flowing between the target surface 928 and the guide surface 936 causes the guide portion 932 of the air guide 924 to extend a short distance above the target surface 928. The guide surface 936 and the target surface 928 thus define a guide space along which the air flowing out of the nozzle 935 passes. The guide space is not sealed.

The air guide 924 comprises an upper panel 950 and a lower panel (not shown) defining the guide surface. In the example air guide 924, the air chambers 934 are formed by longitudinal seams 952 and one edge seam 954 connecting the upper and lower panels, but the air chambers 934 may be formed by other structures.

The seams 952 and 954 of the example air guide 924 substantially parallel to each other so that an overall shape of the air guide 924 is generally rectangular. However, the attachment portion 930 of the air guide 924 is angled with respect to the guide portion 932 so that the air exiting the blower nozzle 935 flows at an angle with respect to a longitudinal axis of the air guide 924. The example system 920 may be used in many different configurations but is optimized for use against a wall structure. When used to dry a wall structure, the air exiting the blower nozzle 935 is directed at the wall structure, with one edge of the air guide 924 abutting the wall structure.

Each air chamber 934 defines an inlet 958 that allows air to enter the chamber 934. While not sealed, the chambers 934 are sufficiently air tight to inflate and stay inflated as long as the air mover 922 is operating. The example attachment portion 930 is formed by a portion 950a of the upper panel 950 that extends beyond the lower panel.

The example air guide 924 further comprises a scoop system 960 and an attachment system 962. The scoop system 960 comprises a relatively rigid scoop member 970 configured to define a scoop inlet 972. The scoop member 970 is sewn to the upper and lower panels of the air guide 924 to form a manifold chamber 974 downstream of the scoop inlet 972. The manifold chamber 974 is defined in part by the outermost side longitudinal seams 952 and in part by the edge seam 954.

The scoop inlet 972 is in fluid communication with the manifold chamber 974, and the manifold chamber 974 is in turn in fluid communication with the inlets 958 of the chambers 934. Substantially all of the air entering the chambers 934 through the inlets 958 thus must pass first through the scoop inlet 972 and then through the manifold chamber 974. The shape and dimensions of the scoop member 970 thus generally determine the amount of air that enters and inflates the chambers 934. The example scoop member 970 defines a generally rectangular scoop inlet 972, but other shapes and dimensions may be used.

The example scoop member 970 is formed by material that is sufficiently rigid to hold the shape of the scoop inlet 972. Although the scoop member 970 may be rigid or flexible, the example scoop member 970 is made of semi-rigid foam material.

The example attachment system 962 comprises a cord member 980 formed in a loop. The example cord member 980 extends through opening portions 982 and 984 of the attachment portion 930. The example cord member 980 is resilient and arranged to resiliently oppose movement of the opening portions 982 and 984 away from each other when the opening portions are separated by more than a minimum spacing distance. The minimum spacing is predetermined so that, when the attachment portion 930 is around the blower nozzle 935, the cord member 980 is under tension. Further, the minimum spacing is such that the tension applied by the cord member 980 to the opening portions 982 and 984 holds the air guide 924 on the blower nozzle 935.

FIG. 37 further shows that the example attachment system 962 comprises an optional strap assembly 990. The strap assembly 990 extends around the blower 922 to prevent the air guide 924 from blowing away should the air guide 924 not stay on the blower nozzle 935. The strap assembly 990 is preferably extensible to allow the strap assembly to accommodate blowers of different sizes and shapes.

What is claimed is:

1. A system for guiding air to at least one desired location on at least one target surface, comprising:
an air mover defining an outlet, where the air mover displaces air through the outlet; and
an air guide member defining at least one air chamber; wherein
the air guide member is arranged adjacent to the outlet such that at least a first portion of the air displaced by the air mover enters the at least one air chamber to inflate the air guide member; and
the air mover and air guide member are arranged such that the inflated air guide member guides a second portion of the air towards the at least one desired location.

2. A system as recited in claim 1, in which the air guide member further defines an attachment portion adapted to be secured to the air mover.

3. A system as recited in claim 1, further comprising a fastening system for securing the air guide member relative to the air mover.

4. A system as recited in claim 2, further comprising a fastening system for securing the attachment portion of the air guide member relative to the air mover.

5. A system as recited in claim 1, in which:
the air guide member further comprises a plurality of air chambers and a manifold chamber;
the manifold chamber is in fluid communication with the air chambers; and
air displaced through the outlet flows into the manifold chamber and then into the plurality of air chambers.

6. A system as recited in claim 1, further comprising a scoop member arranged to direct air into the at least one air chamber.

7. A system as recited in claim 5, further comprising a scoop member arranged to direct air into the manifold chamber.

8. A system as recited in claim 1, in which:
when the air guide member is inflated, the air guide member defines a guide surface; and
the guide surface opposes the at least one target surface.

9. A system as recited in claim 1, in which the air guide member is made of flexible material.

10. A system as recited in claim 1, further comprising at least one weighted member that engages the air guide member.

11. A system as recited in claim 1, further comprising a plurality of air guide members.

12. A system as recited in claim 11, further comprising a plurality of air movers.

13. A method for guiding air towards at least one desired location on at least one target surface, comprising:
displacing air through an outlet;
providing an air guide member defining at least one air chamber;
inflating the air guide member by arranging the air guide member adjacent to the outlet such that at least a first portion of the air displaced by the air mover enters the at least one air chamber; and
arranging the air mover and air guide member such that the inflated air guide member guides a second portion of the air towards the at least one desired location.

14. A method as recited in claim 13, further comprising the step of securing the air guide member to the air mover.

15. A method as recited in claim 13, further comprising the steps of:
forming an attachment portion of the air guide member; and
securing the attachment portion of the air guide member relative to the air mover.

16. A method as recited in claim 1, further comprising the steps of:
forming the air guide member to define a plurality of air chambers and a manifold chamber, where the manifold chamber is in fluid communication with the air chambers;
causing air displaced through the outlet to flow into the manifold chamber; and
causing air displaced through the manifold chamber to flow into the plurality of air chambers.

17. A method as recited in claim 13, further comprising the step of arranging a scoop member to direct air into the at least one air chamber.

18. A method as recited in claim 16, further comprising the step of arranging a scoop member to direct air into the manifold chamber.

19. A method as recited in claim 13, in which:
when the air guide member is inflated, the air guide member defines a guide surface; and
the guide surface opposes the at least one target surface.

20. A method as recited in claim 13, in which the step of providing the air guide member comprises the step of forming the air guide member from flexible material.

21. A method as recited in claim 13, further comprising the step of arranging at least one weighted member to engage the air guide member.

22. A method as recited in claim 13, further comprising the step of providing a plurality of air guide members.

23. A method as recited in claim 22, further comprising the step of providing a plurality of air movers.
